(19) United States
(12) Patent Application Publication
(10) Pub. No.: US 2016/0240307 A1
(43) Pub. Date: Aug. 18, 2016

(54) COIL COMPONENT, HIGH CURRENT INDCUTOR, HIGH CURRENT REACTOR INLCUDING THE SAME

(71) Applicant: LG INNOTEK CO., LTD., Seoul (KR)

(72) Inventors: Jai Hoon YEOM, Seoul (KR); SoYeon KIM, Seoul (KR); Seok BAE, Seoul (KR); Sang Won LEE, Seoul (KR); Jong Soo HAN, Seoul (KR)

(73) Assignee: LG INNOTEK CO., LTD.

(21) Appl. No.: 15/019,194

(22) Filed: Feb. 9, 2016

(30) Foreign Application Priority Data
Feb. 12, 2015 (KR) 10-2015-0021332

(51) Int. Cl. H01F 27/32; H01F 27/255

(52) U.S. Cl. CPC H01F 27/325; H01F 27/255

(57) ABSTRACT

A coil component, a high current inductor including a coil component, and a high current reactor including a coil component are provided. The coil component may include a magnetic core, a bobbin that surrounds a portion of the magnetic core, and a coil wound on the bobbin. Accordingly, noise generated by friction between the magnetic core and the bobbin may be reduced.

### CROSS-REFERENCE TO RELATED APPLICATION

This application claims priority under 35 U.S.C. §119 to Korean Patent Application No. 10-2015-0021332, filed Feb. 12, 2015, whose entire disclosure is incorporated herein by reference.

### BACKGROUND

1. Field

Embodiments relate to a coil component, a high current inductor including a coil component, and a high current reactor including a coil component.

2. Background

An inductor or reactor, which may be used in, for example, a solar photovoltaic system, a wind power generation system, and an electric car, may include a coil wound on a magnetic core. The magnetic core is surrounded by a bobbin, and a coil is wound on the bobbin. When an external magnetic field is applied to a magnetic material, magnetic transformation occurs, and a shape or dimension change may be generated. This phenomenon is called magnetostriction, and an intrinsic magnetostriction value exists for each magnetic material. When an external magnetic field is applied to a magnetic material, the magnetic core and the bobbin may rub each other due to the magnetostriction, and a noise of high frequency may be generated. A high current inductor for power factor correction (PFC) and a high current reactor for the PFC may be provided indoors or in a limited space, where usage may be problematic because of noise due to magnetostriction.

### BRIEF DESCRIPTION OF THE DRAWINGS

The embodiments will be described in detail with reference to the following drawings in which like reference numerals refer to like elements wherein:

FIG. 1 is a diagram illustrating magnetostriction due to an external magnetic field;

FIG. 2 is a graph showing a relationship among inductance, permeability, and noise generation.

FIG. 3 is a diagram illustrating a side surface of a coil component according to an embodiment;

FIG. 4 is a diagram illustrating a top surface of a coil component according to an embodiment;

FIG. 5 is a diagram illustrating a magnetic core and a bobbin according to an embodiment;

FIG. 6 is a diagram illustrating a top surface of a coil component according to another embodiment;

FIG. 7 is a diagram illustrating a magnetic core and a bobbin according to another embodiment;

FIG. 8 is a diagram illustrating a top surface of a coil component according to still another embodiment; and

FIG. 9 is a graph showing measurement results of noise from an embodiment and noise from a comparative example.

### DETAILED DESCRIPTION

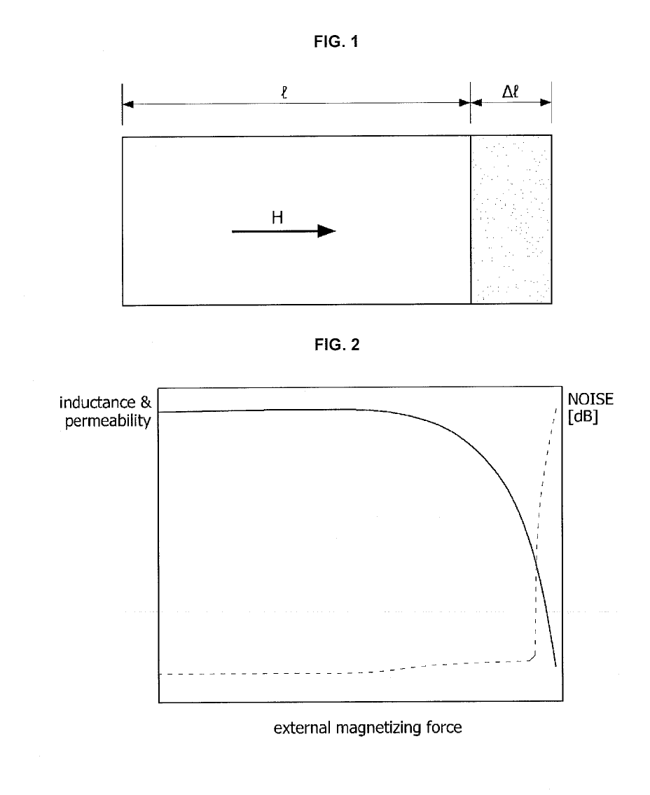

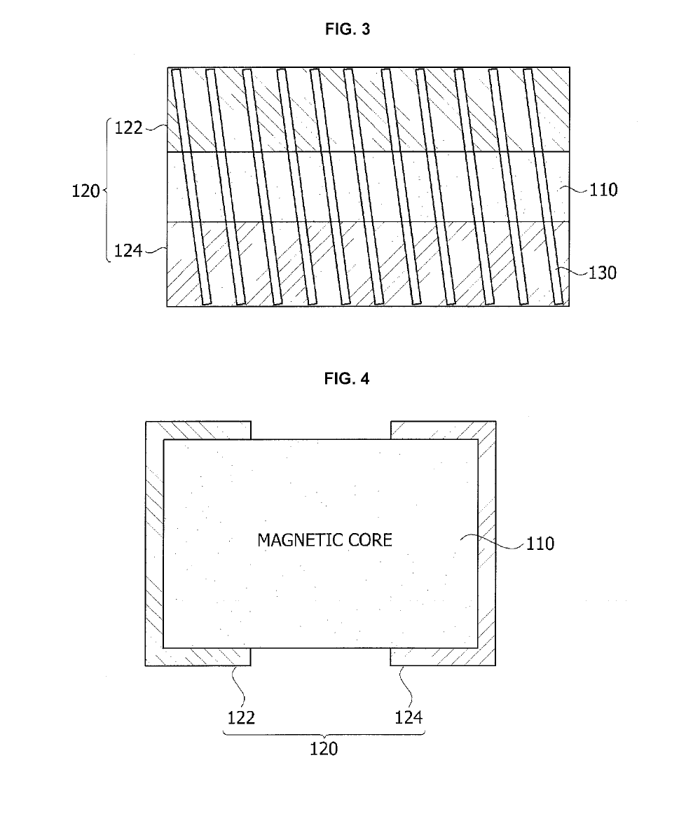

FIG. 1 is a diagram illustrating magnetostriction due to an external magnetic field. FIG. 2 is a graph showing a relationship among inductance, permeability, and noise generation. Referring to FIG. 1, when an external magnetic field H is applied to a magnetic material, the magnetic material may be magnetized and a shape of the magnetic material may be changed. This magnetic change, or a magnetostriction value, may be defined by Equation 1.

λ=Δl/l [Equation 1]

where l denotes a length of a magnetic material, and Δl denotes a change in the length of the magnetic material due to a change in magnetic field. Intrinsic magnetostriction values (λs) of magnetic materials are indicated in Table 1.

TABLE 1

| Magnetic material | Bₛ (T) | T_{c} (° C.) | ρ (×10⁻⁸) [Ωm] | λₛ (×10⁻⁶) |
|---|---|---|---|---|
| Fe—Si—B | 1.56 | 395 | 130 | 27 |
| Fe—Ni | 1.5 | 500 | 40 | 0~4 |
| Fe—Si | 1.5~1.6 | 725 | 80 | 0 |
| Fe—Si—Al | 1.0 | 500 | 80 | 0 |
| Fe—Ni—Mo | 0.75 | 450~460 | 60 | 7.2 |
| Fe—B—Si—Nb—Cu | 1.2 | 560 | 110 | 0 |

Referring to Table 1, a Fe—Ni-based magnetic material having a high flux, a Fe—Si-based magnetic material having a mega flux, a Fe—Si—Al-based magnetic material, which may be sendust, and a Fe—B—Si—Nb—Cu-based magnetic material may each have a magnetostriction value close to 0. An amorphous magnetic material, for example, a Fe—Si—B-based magnetic material, and a permalloy magnetic material, for example, a Fe—Ni—Mo-based magnetic material, may have high magnetostriction values.

Referring to FIG. 2, as external magnetizing force increases, magnetic characteristics, such as, for example, inductance and permeability, may be improved, but noise due to magnetostriction may be increased. According to an embodiment disclosed herein, noise generation due to magnetostriction may be prevented by decreasing a gap formed between a magnetic core and a bobbin winding the magnetic core.

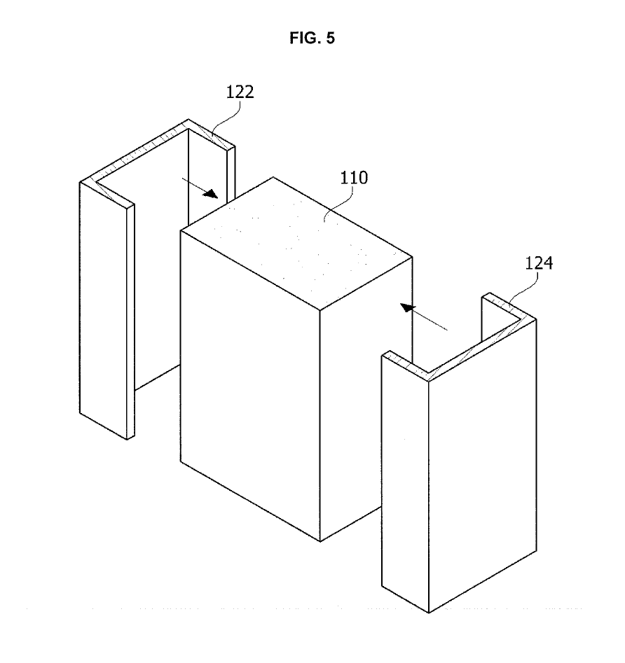

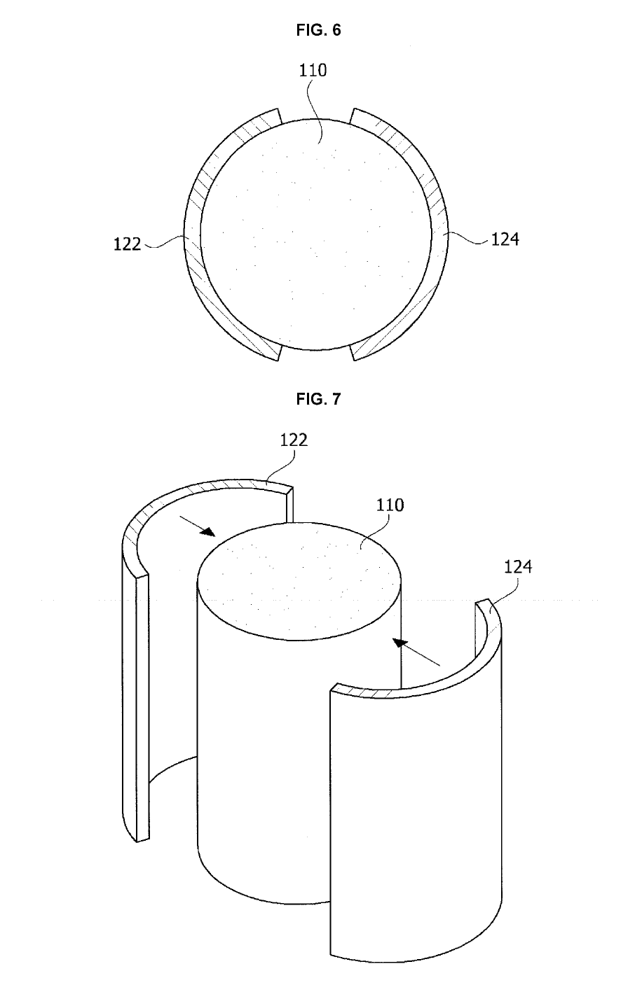

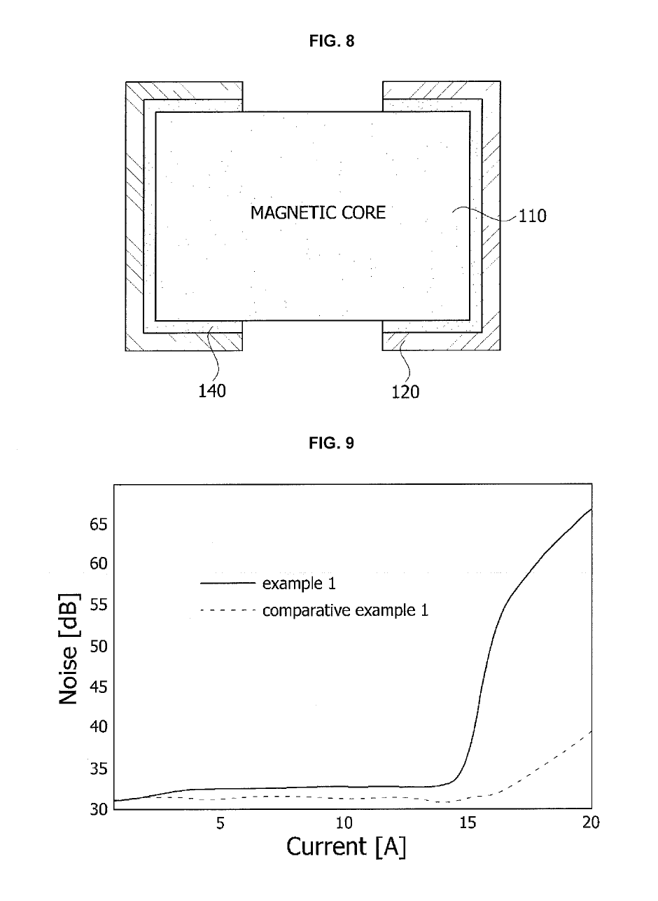

FIG. 3 is a diagram illustrating a side surface of a coil component according to an embodiment. FIG. 4 is a diagram illustrating a top surface of a coil component according to an embodiment. FIG. 5 is a diagram illustrating a magnetic core and a bobbin according to an embodiment. FIG. 6 is a diagram illustrating a top surface of a coil component according to another embodiment. FIG. 7 is a diagram illustrating a magnetic core and a bobbin according to another embodiment. FIG. 8 is a diagram illustrating a top surface of a coil component according to still another embodiment.

Referring to FIGS. 3 to 5, a coil component according to an embodiment may include a magnetic core 110, a bobbin 120 that surrounds a portion of the magnetic core 110, and a coil 130 wound on or around the bobbin 120. When the bobbin 120 surrounds a portion of the magnetic core 110 rather than an entirety of the magnetic core 110, a gap between the magnetic core 110 and the bobbin 120 may be decreased due to a force of the coil 130 wound on the bobbin 120. Therefore, noise generated by friction between the magnetic core 110 and the bobbin 120 may be reduced.

The magnetic core 110 may be made by coating a magnetic powder with a ceramic or a polymer binder and performing insulation and shaping at a high pressure. The magnetic core 110 may have a three-dimensional shape such as, e.g., a cylinder or a prism. The magnetic powder may be a powder of a metal alloy having a soft magnetic property and may include, for example, pure iron, a silicon steel plate, an amorphous magnetic powder, a permalloy magnetic powder, a high flux (HF) magnetic powder, and a sendust magnetic powder. For example, the magnetic powder may include at least one selected from a group composed of Fe—Si—B-based magnetic power, Fe—Ni-based magnetic power, Fe—Si-based magnetic power, Fe—Si—Al-based magnetic power, Fe—Ni—Mo-based magnetic power, and Fe—B—Si—Nb—Cu-based magnetic power.

The bobbin 120 may surround a portion of a side surface of the magnetic core 110. The bobbin 120 may include a first bobbin 122 that surrounds a portion of a side surface of the magnetic core 110 and a second bobbin 124 that is separate from the first bobbin 122 and that surrounds a portion of the side surface of the magnetic core 110. The first bobbin 122 and the second bobbin 124 may be symmetrically provided on either side surfaces of the magnetic core 110. When the bobbin 120 surrounds a portion of the magnetic core 110 rather than the entirety pf the magnetic core 110 and the coil 130 is wound on the bobbin 120, a gap between the magnetic core 110 and the bobbin 120 may be decreased due to a force of winding of the coil 130. Thus, the bobbin 120 and the magnetic core 110 may come close to each other, and noise generated by friction between the bobbin 120 and the magnetic core 110 may be reduced. The bobbin 120 may include plastic or a metal having an insulated surface.

The bobbin 120 may surround an area of 40% to 90% of the side surface of the magnetic core 110, for example, 50% to 80% of the side surface of the magnetic core 110. When the bobbin 120 surrounds beyond 90% of the area of the side surface of the magnetic core 110, a noise reduction effect is decreased because of an increase in a frictional area between the bobbin 120 and the magnetic core 110. When the bobbin 120 surrounds less than 40% of the area of the side surface of the magnetic core 110, the noise reduction effect is decreased because noise generated by a vibration of the magnetic core 110 transfers to an outside of the bobbin 120, and an area where the coil 130 and the magnetic core 110 directly touch may be generated.

Although the magnetic core 110 having a prism shape is described in FIGS. 3 to 5, a shape of the magnetic core 110 may not be limited thereto. For example, as shown in FIGS. 6 and 7, the magnetic core 110 may have a shape of a cylinder, and the bobbin 120 may have a shape corresponding to the cylinder shape. As shown in FIG. 8, an interlayer 140 may be provided between the magnetic core 110 and the bobbin 120. The interlayer 140 may be a layer having a rigidity higher than a rigidity of the magnetic core 110 and the bobbin 120. The interlayer 140 may include silicon or an insulating material. Thus, the bobbin 120 and the magnetic core 110 may come closer to each other, and noise may be reduced. The interlayer 140 may include, for example, a film including a silicon-based polymer resin and an insulating layer coated on both sides of the film.

The coil component according to an embodiment may be fabricated or made as a block unit and may be applied to, for example, a high current inductor for power factor correction (PFC), a high current reactor for the PFC, an inductor filter for an inverter of a solar photovoltaic system or a wind power generation system, an inductor for a large capacity DC-DC converter of a solar photovoltaic system and an electric car, and an inductor for vehicle electronics.

### Example 1

A magnetic core having a prism shape was fabricated by coating a Fe—Si—B-based magnetic powder with a polymer binder and performing insulation and shaping at a high pressure. A coil was wound after surrounding 80% of an area of a side surface of the magnetic core with two symmetrical bobbins.

### Example 2

A magnetic core having a prism shape was fabricated by coating a Fe—Si—B-based magnetic powder with a polymer binder and performing insulation and shaping at a high pressure. A coil was wound after surrounding 50% of an area of a side surface of the magnetic core with two symmetrical bobbins.

### Comparative Example 1

A magnetic core having a prism shape was fabricated by coating a Fe—Si—B-based magnetic powder with a polymer binder and performing insulation and shaping at a high pressure. A coil was wound after surrounding a whole area of a side surface of the magnetic core by one bobbin.

### Comparative Example 2

A magnetic core having a prism shape was fabricated by coating a Fe—Si—B-based magnetic powder with a polymer binder and performing insulation and shaping at a high pressure. A coil was wound after surrounding 20% of an area of a side surface of the magnetic core with two symmetrical bobbins.

A current was applied to each coil of example 1, example 2, comparative example 1, and comparative example 2, and noise values at 4 kH to 10 kH were measured.

Table 2 represents noise values measured after applying current to example 1 and example 2. FIG. 9 is a graph showing measured results of noise from example 1 and comparative example 1.

TABLE 2

| Experiment Number | Applied area of a bobbin | Noise |
|---|---|---|
| Example 1 | 80% | 45~50 dB |
| Example 2 | 50% | 40~45 dB |
| Comparative Example 1 | 100% | 55~60 dB |
| Comparative Example 2 | 20% | 50~55 dB |

Referring to Table 2 and FIG. 9, when an applied area of the bobbins are 80% and 50% of the side surface of the magnetic core as in example 1 and example 2, respectively, the noise generated is lower compared to comparative example 1 and comparative example 2, where an applied area of the bobbins are 100% and 20% of the side surface of the magnetic core, respectively.

According to embodiments disclosed herein, noise generation due to magnetostriction of a coil component may be reduced. Thus, a selection range of a magnetic material for a magnetic core included in the coil component may be widened. The coil component according to an embodiment may be fabricated as a block unit and may be applied to, for example, a high current reactor for power factor correction (PFC), a high current inductor for the PFC, an inductor filter for an inverter of a solar photovoltaic system or a wind power generation system, an inductor for a large capacity DC-DC converter of a solar photovoltaic system and an electric car, and an inductor for electronics of a vehicle.

Embodiments disclosed herein provide a coil component, and a high current inductor and a high current reactor including the coil component. According to embodiments disclosed herein, a coil component may include a magnetic core, a bobbin that surrounds a portion of the magnetic core, and a coil wound on the bobbin. The bobbin may surround a portion of a side surface of the magnetic core. The bobbin may surround an area of 40% to 90% of the side surface of the magnetic core.

The coil component may further include an interlayer formed between the magnetic core and the bobbin. The interlayer may include silicon. The bobbin may include plastic or metal having an insulated surface. The magnetic core may include at least one selected from a group composed of Fe—Si—B-based magnetic power, Fe—Ni-based magnetic power, Fe—Si-based magnetic power, Fe—Si—Al-based magnetic power, Fe—Ni—Mo-based magnetic power, and Fe—B—Si—Nb—Cu-based magnetic power.

Embodiments disclosed herein also provide a coil component, which may include a magnetic core, a first bobbin that surrounds a first portion of a side surface of the magnetic core, a second bobbin that is separate from the first bobbin and that surrounds a second portion of the side surface of the magnetic core, and a coil wound on the bobbin. The first bobbin and the second bobbin may be symmetrically provided on either side surfaces of the magnetic core.

Embodiments disclosed herein provide a high current inductor for power factor correction including at least one coil component, which may include a magnetic core, a bobbin surrounding a portion of the magnetic core, and a coil wound on the bobbin. Embodiments disclosed herein provide a high current reactor for power factor correction including at least one coil component, which may include a magnetic core, a bobbin surrounding a portion of the magnetic core, and a coil wound on the bobbin.

It will be understood that, although the terms “first,” “second,” etc. may be used herein to describe various components, these components should not be limited by these terms. These terms are only used to distinguish one component from another component. Thus, a first component discussed below could be termed a second component and the second component discussed below could be termed the first component without departing from the teachings of the present inventive concept. The “and/or” includes each and all combinations of one or more of the items mentioned.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A coil component, comprising:
a magnetic core;
a bobbin that surrounds a portion of the magnetic core; and
a coil wound on the bobbin.

2. The coil component of claim 1, wherein the bobbin surrounds a portion of a side surface of the magnetic core.

3. The coil component of claim 2, wherein the bobbin surrounds an area of 40% to 90% of the side surface of the magnetic core.

4. The coil component of claim 3, wherein the bobbin surrounds an area of 50% to 80% of the side surface of the magnetic core.

5. The coil component of claim 1, further comprising:
an interlayer provided between the magnetic core and the bobbin.

6. The coil component of claim 5, wherein the interlayer includes at least one of silicon (Si) and an insulating material.

7. The coil component of claim 6, wherein the interlayer includes:
a film including a silicon-based polymer resin; and
an insulating layer coated on both sides of the film.

8. The coil component of claim 6, wherein the interlayer is configured to have a rigidity higher than a rigidity of the magnetic core and the bobbin.

9. The coil component of claim 1, wherein the bobbin includes one of a plastic or a metal having an insulated surface.

10. The coil component of claim 1, wherein the magnetic core includes at least one of a Fe—Si—B-based magnetic power, a Fe—Ni-based magnetic power, a Fe—Si-based magnetic power, a Fe—Si—Al-based magnetic power, a Fe—Ni—Mo-based magnetic power, and a Fe—B—Si—Nb—Cu-based magnetic power.

11. The coil component of claim 1, wherein the bobbin includes:
a first bobbin that surrounds a first portion of a side surface of the magnetic core; and
a second bobbin that is separate from the first bobbin and that surrounds a second portion of the side surface of the magnetic core.

12. The coil component of claim 11, wherein the first bobbin and the second bobbin are symmetrically provided on side surfaces of the magnetic core.

13. A high current inductor for power factor correction including at least one coil component, the coil component comprising:
a magnetic core;
a bobbin that surrounds a portion of the magnetic core; and
a coil wound on the bobbin.

14. The high current inductor of claim 13, wherein the bobbin surrounds a portion of a side surface of the magnetic core.

15. The high current inductor of claim 13, further comprising:
an interlayer provided between the magnetic core and the bobbin.

16. The high current inductor of claim 13, wherein the bobbin includes:
a first bobbin that surrounds a first portion of a side surface of the magnetic core; and
a second bobbin that is separate from the first bobbin and that surrounds a second portion of the side surface of the magnetic core.

17. A high current reactor for power factor correction including at least one coil component, the coil component comprising:
a magnetic core;
a bobbin that surrounds a portion of the magnetic core; and
a coil wound on the bobbin.

18. The high current reactor of claim 17, wherein the bobbin surrounds a portion of a side surface of the magnetic core.

19. The high current reactor of claim 17, further comprising:
an interlayer provided between the magnetic core and the bobbin.

20. The high current reactor of claim 17, wherein the bobbin includes:
a first bobbin that surrounds a first portion of a side surface of the magnetic core; and
a second bobbin that is separate from the first bobbin and that surrounds a second portion of the side surface of the magnetic core.
